(19) United States
(12) Patent Application Publication
(10) Pub. No.: US 2026/0237618 A1
(43) Pub. Date: Aug. 13, 2026

(54) METHOD FOR ANALYZING ORGANIC ACID IN TISSUE PIECE

(71) Applicants: SHIMADZU CORPORATION, Kyoto-shi (JP); NATIONAL UNIVERSITY CORPORATION KOBE UNIVERSITY, Kobe-shi (JP)

(72) Inventors: Kaoru NAKAGAWA, Kyoto-shi (JP); Akiko KUBO, Kobe-shi (JP)

(73) Assignees: SHIMADZU CORPORATION, Kyoto-shi (JP); NATIONAL UNIVERSITY CORPORATION KOBE UNIVERSITY, Kobe-shi (JP)

(21) Appl. No.: 19/534,640

(22) Filed: Feb. 9, 2026

(30) Foreign Application Priority Data
Feb. 12, 2025 (JP) 2025-020569

(51) Int. Cl. H01J 49/00

(52) U.S. Cl. CPC H01J 49/0027

(57) ABSTRACT

An object of the present invention is to provide a method capable of analyzing components other than an organic acid in addition to the organic acid in a tissue piece. A method for analyzing an organic acid in a tissue piece includes, in order, a derivatization step of derivatizing an organic acid present in a tissue piece by dehydration condensation, a coating step of coating the tissue piece with a matrix having a carboxyl group by a vapor deposition method, and a detection step of performing matrix-assisted laser desorption/ionization mass spectrometry on the tissue piece to detect the derivatized organic acid.

### CROSS REFERENCE TO RELATED APPLICATIONS

This application claims priority to Japanese Patent Application No. 2025-020569 filed on Feb. 12, 2025, the entire disclosure of which is incorporated by reference herein.

### BACKGROUND OF THE INVENTION

### Field of the Invention

The present invention relates to a method for analyzing an organic acid in a tissue piece.

### Description of the Related Art

Since organic acids such as short-chain fatty acids produced by intestinal bacteria adjust the intestinal environment and exhibit various physiological effects such as anti-inflammatory effects, it has become important to perform analysis while maintaining the spatial distribution of short-chain fatty acids in the body. However, since short-chain fatty acids have high volatility and low ionization efficiency, there is no report on a method for directly detecting these in a method such as mass spectrometry imaging.

Therefore, Chenglong Sun, Wei Liu, Yanling Geng, Xiao Wang: On-tissue derivatization strategy for mass spectrometry imaging of carboxyl-containing Metabolites in biological tissues: analytical chemistry. 2020, 92, 12126-12131. (Non Patent Literature 1) reports a method of derivatizing and measuring an organic acid. Specifically, N,N,N-trimethyl-2-(piperazin-1-yl) ethan-1-aminium iodide (TMPA), which is a derivatization reagent, is applied to a tissue piece of a mouse brain or kidney together with a condensing agent (for example, HATU) and a carboxylic acid activator (for example, HOBt), and the organic acid in the tissue piece is derivatized and reacted in acetonitrile vapor. Thereafter, 1,5-diaminonaphthalene (DAN) as a matrix is applied to the derivatized tissue piece, and a matrix-assisted laser desorption/ionization mass spectrometry imaging method (MALDI mass imaging method) is performed.

### SUMMARY OF THE INVENTION

However, in the method of Non Patent Literature 1, since a carboxyl group of organic acid is derivatized with TMPA and then a matrix solution is applied, it is necessary to use a compound that is not derivatized with TMPA, that is, a compound that does not contain a carboxyl group, as the matrix. Therefore, DAN is used as a matrix. MALDI requires selection of a matrix corresponding to a component desired to be detected. However, when DAN, which is generally used in an anion mode, is used as a matrix for MALDI analysis in a cation mode, a large number of interference ions are generated, and thus molecular ions having a weak ionic strength, which are not TMPA-derivatized, are hardly detected under a suppression effect. Further, the peak of TMPA-derivatized butyric acid, which is a representative short-chain fatty acid, and the peak of interference ions derived from DAN are very close to each other, and the accurate distribution of TMPA-derivatized butyric acid cannot be known. That is, a problem that a compound other than the TMPA derivatized organic acid is hardly detected occurs. In the tissue piece, metabolites such as cholesterol are produced in addition to the organic acid, and it is desired to simultaneously measure such metabolites.

An object of the present invention is to provide a method capable of analyzing components other than an organic acid in addition to the organic acid in a tissue piece. Alternatively, an object of the present invention is to provide an analysis method for accurately knowing the distribution of an organic acid containing a short-chain fatty acid in a tissue piece.

A method for analyzing an organic acid in a tissue piece according to a first aspect of the present invention includes, in order, a derivatization step of derivatizing an organic acid present in a tissue piece by dehydration condensation, a coating step of coating the tissue piece with a matrix having a carboxyl group by a vapor deposition method, and a detection step of performing matrix-assisted laser desorption/ionization mass spectrometry on the tissue piece to detect the derivatized organic acid.

According to the first aspect of the present invention, in addition to the organic acid, components other than the organic acid can also be analyzed in the tissue piece.

### DETAILED DESCRIPTION OF THE PREFERRED EMBODIMENTS

### 1. First Embodiment

As a first aspect of the present invention, a method for analyzing an organic acid according to a first embodiment includes a derivatization step, a coating step, and a detection step in order. Hereinafter, each step will be described in detail.

### (Derivatization Step)

In this step, a tissue piece is prepared, and the tissue piece is subjected to a derivatization treatment. For example, an organic acid present in a tissue section is combined with a compound having a quaternary amine by dehydration condensation and derivatized. Thereby, a derivatized tissue section in which the organic acid is derivatized is obtained.

The prepared tissue pieces to be analyzed are those cut or collected from a part of an organism such as a human, an animal, or a plant, and examples thereof include a brain, an organ (intestines, kidneys, lungs, and the like), a skin, a bone, a muscle, and a fat.

Examples of the derivatizing agent used for derivatization include N,N,N-trimethyl-2-(piperazin-1-yl) ethan-1-aminium iodide (TMPA), N, N-dimethylpiperazine iodide (DMPI), and 1-(4-(aminomethyl)phenyl)pyridine-1-ium chloride (AMPP).

In the derivatization treatment, a basic substance is preferably added. This can accelerate the derivatization reaction. Examples of the basic substance include 4-methylmorpholine (4 MM) and triethylamine (TEA).

In addition to the derivatizing agent, a condensing agent is added. This makes it possible to produce the derivatized organic acid with a high recovery rate. Examples of the condensing agent include hexafluorophosphates such as a compound (HATU) represented by the following Formula (1), a compound (HBTU) represented by the following Formula (2), and a compound (COMU) represented by the following Formula (3).

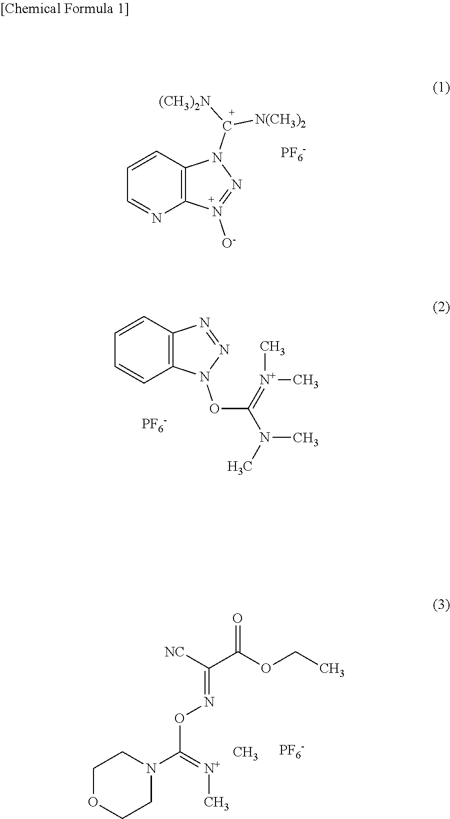

As the derivatization treatment, specifically, a derivatizing agent, a condensing agent, and if necessary, a basic substance are dissolved in an organic solvent, and a mixed solution thereof is applied and brought into contact with a tissue section by a method such as spraying. Thereafter, incubation is performed under an atmosphere filled with an organic solvent.

The organic solvent may be any solvent that dissolves the derivatizing agent, and examples thereof include acetonitrile, dimethylformamide, dimethyl sulfoxide, acetone, ethanol, methanol, and ethylene glycol. These can be used alone or in combination with two or more. Preferred is acetonitrile from the viewpoint of solubility and reactivity.

As the organic solvent used in the atmosphere at the time of incubation, the same organic solvent as the organic solvent in which the derivatizing agent is dissolved is preferably carried out, and acetonitrile is particularly preferable. The incubation time is, for example, 30 minutes or more and 24 hours or less, and the incubation temperature is, for example, 10° C. or more and 50° C. or less.

### (Coating Step)

In this step, the derivatized tissue section is coated with a matrix by a vapor deposition method. Thus, a coated tissue section in which the surface of the derivatized tissue is coated with the matrix is obtained.

The matrix is a matrix for MALDI used in the detection step described later, and contains a compound having a carboxyl group. In MALDI analysis, selection of a matrix is important, and selection according to a detection target compound needs to be made. Many matrices with high versatility in cation mode analysis have carboxyl groups. By performing mass spectrometry using this matrix, a wide range of compounds (metabolites such as cholesterol) can be ionized in addition to the derivatized organic acid, and distribution analysis can be accurately performed. As a result, in the tissue piece, the distribution of the organic acid containing the short-chain fatty acid can be accurately known.

Examples of such a matrix include α-cyano-4-hydroxycinnamic acid (CHCA) and 2,5-dihydroxybenzoic acid (DHB). These can be used alone or in combination with two or more. In particular, in the first embodiment, in order to suppress the reaction with the derivatization reagent, it is preferable that the matrix does not contain, for example, a solvent such as water or an organic solvent, and it is more preferable that the matrix is substantially composed only of the above compound.

Examples of the vapor deposition method include a vacuum vapor deposition method. Specifically, the matrix is heated and sublimated in vacuum, and the sublimated matrix is coated on the derivatized tissue piece that is the object. For performing this vapor deposition method, it is sufficient to use a known or commercially available vapor deposition apparatus, and examples thereof include a vacuum vapor deposition apparatus (specifically, iMLayer (registered trademark)) manufactured by Shimadzu Corporation.

The thickness of the matrix film coated by the vapor deposition method is, for example, 0.1 μm or more, preferably 0.5 μm or more, and is, for example, 5.0 μm or less, preferably 2.0 μm or less. Within this range, derivatized organic acids and metabolites present in tissue pieces can be efficiently ionized, and distribution analysis with high spatial resolution using MALDI mass spectrometry can be reliably performed.

### (Detection Step)

In this step, imaging mass spectrometry using matrix-assisted laser desorption/ionization (MALDI) mass spectrometry is performed on the coated tissue piece. That is, MALDI imaging mass spectrometry is performed. This makes it possible to detect the derivatized organic acid in the tissue piece and to perform distribution analysis of the organic acid with high spatial resolution.

Imaging mass spectrometry refers to a method of visualizing or mapping the distribution of a compound in a tissue piece by superimposing a morphology image observed with an optical microscope and mass information obtained by mass spectrometry. In addition, imaging mass spectrometry using MALDI mass spectrometry refers to a method of performing MALDI at the time of ionization of a measurement target in mass spectrometry in mass spectrometry imaging method. That is, it refers to a method of mixing a matrix and an object to be measured, irradiating the matrix and the object to be measured with a laser to ionize the object to be measured, and performing imaging mass spectrometry.

For implementation of the MALDI mass spectrometry, for example, it is sufficient to perform an operation according to a conventional method using a matrix-assisted laser desorption/ionization-time of flight (MALDI-TOF) type mass spectrometer, a matrix-assisted laser desorption/ionization-ion trap (MALDI-IT) type mass spectrometer, a matrix-assisted laser desorption/ionization-ion trap-time of flight (MALDI-IT-TOF) type mass spectrometer, a matrix-assisted laser desorption/ionization-Fourier transform ion cyclotron resonance (MALDI-FTICR) type mass spectrometer, or the like. Also for implementation of the imaging mass spectrometry, it is sufficient to perform an operation according to a conventional method using a known or commercially available imaging mass spectrometer or the like. That is, the present process can be performed by combining a known or commercially available MALDI mass spectrometer and an imaging mass spectrometer.

According to the first embodiment, an imaging mass spectrometry image showing the presence of a derivatized organic acid (as a result, an organic acid) and another compound is obtained for a tissue piece. Thereby, the organic acid and other metabolites present in the tissue piece can be simultaneously analyzed. The organic acid is preferably a fatty acid. As the fatty acid, examples include short-chain fatty acids having 6 or less carbon atoms such as acetic acid, propionic acid, lactic acid, butyric acid, valeric acid, and caproic acid; medium-chain fatty acids having 7 to 11 carbon atoms such as caprylic acid and capric acid; and long-chain fatty acids having 12 or more carbon atoms such as lauric acid, palmitic acid, stearic acid, palmitoleic acid, oleic acid, and linoleic acid. These can be analyzed alone or in combination with two or more. In the present invention, preferably, short-chain fatty acids having high volatility and low ionization efficiency can be analyzed sufficiently, and thus the present invention is particularly suitable for analysis of short-chain fatty acids. Examples of other metabolites include cholesterol and phospholipids. In particular, the present invention is suitable for simultaneous analysis of short-chain fatty acids and cholesterol, and further suitable for simultaneous analysis of short-chain fatty acids, long-chain fatty acids, and cholesterol. Among them, a fatty acid is detected as a derivatized fatty acid by mass spectrometry, whereas other compounds such as cholesterol are ionized as they are, without being derivatized, and detected by mass spectrometry.

Conventionally, in order to avoid that a carboxyl group-containing matrix reacts with a derivatization reagent to form strong interference ions, a matrix having no carboxyl group is brought into contact with a tissue piece containing a derivatization reagent by a spray method. Even in this case, since the matrix is an amino group-containing matrix used in an anion mode, interference ions derived from the matrix are also generated, and accurate detection is difficult in mass spectrometry. On the other hand, according to the first embodiment, MALDI mass spectrometry is performed by coating a tissue piece coated with a derivatization reagent with a carboxyl group-containing matrix by a vapor deposition method. Since this form is a method not using an organic solvent, the reaction between the carboxyl group-containing matrix and the derivatization reagent can be suppressed, and generation of interference ions can be suppressed. Furthermore, due to the excellent ionization efficiency of the carboxyl group-containing matrix, not only derivatized organic acids but also other metabolites can be ionized, and these can be detected simultaneously.

### 2. Other Embodiments

In the analysis method of the first embodiment, MALDI imaging mass spectrometry is performed in the detection step, but for example, only MALDI mass spectrometry may be performed without performing imaging mass spectrometry. It is preferable to perform MALDI imaging mass spectrometry from the perspective that visualizing a tissue piece as a map in an image enables detailed examination of the distributions of organic acids and the like.

### 3. Aspects

It is understood by those skilled in the art that the plurality of exemplary embodiments described above are specific examples of the following aspects.
(Item 1) A method for analyzing an organic acid in a tissue piece according to one aspect may include, in order, a derivatization step of derivatizing an organic acid present in a tissue piece by dehydration condensation, a coating step of coating the tissue piece with a matrix having a carboxyl group by a vapor deposition method, and a detection step of performing matrix-assisted laser desorption/ionization mass spectrometry on the tissue piece to detect the derivatized organic acid.
(Item 2) In the method for analyzing according to item 1, the matrix may be at least one of x-cyano-4-hydroxycinnamic acid or 2,5-dihydroxybenzoic acid.
(Item 3) In the method for analyzing according to item 1 or 2, in the derivatization step, the organic acid may be derivatized using a derivatizing agent and a basic substance.
(Item 4) In the method for analyzing according to any one of items 1 to 3, in the detection step, cholesterol may be detected in addition to the organic acid.
(Item 5) In the method for analyzing according to any one of items 1 to 4, in the detection step, the matrix-assisted laser desorption/ionization mass spectrometry may be matrix-assisted laser desorption/ionization mass spectrometry imaging method, and an image showing a distribution of the organic acid may be obtained.

### EXAMPLES

Next, the present invention will be described in detail with reference to Example and Comparative Examples, but the scope of the present invention is not limited thereto.

### Example 1

As tissue pieces, frozen mouse small intestine and large intestine having a thickness of 10 μm were prepared, and dried at −20° C. in a cryostat. Acetonitrile containing 2 mM TMPA (N,N,N-trimethyl-2-(piperazin-1-yl) ethan-1-aminium iodide), 2 mM HATU (compound represented by the above formula (1)) and 2 mM 4 MM (4-methylmorpholine) was prepared and sprayed onto tissue pieces using a spray device (“iMLayer (registered trademark) AERO”, manufactured by Shimadzu Corporation). The coated tissue pieces were incubated for 4 hours at room temperature under an atmosphere filled with acetonitrile gas. The reaction of the fatty acid in the tissue piece at this time is shown below as a reference (R represents a residue obtained by removing a carboxyl group from a fatty acid).

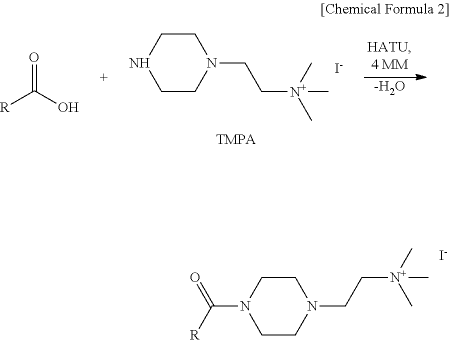

Thereafter, CHCA (α-cyano-4-hydroxycinnamic acid) was vapor-deposited on the tissue piece with a thickness of 0.7 μm using a matrix vapor deposition apparatus (“iMLayer”, manufactured by Shimadzu Corporation). Thus, a sample for MALDI was obtained.

The obtained sample for MALDI was set in an imaging mass microscope (“iMScope QT”, manufactured by Shimadzu Corporation) equipped with an atmospheric pressure matrix-assisted laser desorption/ionization source and a Q-TOF mass spectrometer (“LCMS-9030”, manufactured by Shimadzu Corporation), and mass spectrometry imaging was performed.

### <Imaging Mass Spectrometry Conditions>

Apparatus: iMScope QT+LCMS-9030
Polarity: positive
DL temperature: 290° C.
Heat block temperature: 450° C.
MS range: m/z 200 to 500
Spatial resolution (pitch): Oct. 25, 1950 μm
Laser diameter setting: 1/2/4
Laser intensity: 36/44/58
Laser repetition frequency: 1 kHz
Shot: 50/spot

TABLE 1

| | Monoisotopic | TMPA-adduct M.W. |
|---|---|---|
| | M.W. | [M]⁺ |
| Propionic acid | 74.0366 | 228.2064 |
| Butyric acid | 88.0522 | 242.2225 |
| Lactic acid | 90.0315 | 244.2018 |
| Palmitoleic acid | 254.2238 | 408.3941 |
| Palmitic acid | 256.2394 | 410.4097 |
| Linoleic acid | 280.2394 | 434.4097 |
| Oleic acid | 282.2550 | 436.4253 |
| Stearic acid | 284.2706 | 438.4409 |

| | Monoisotopic | |
|---|---|---|
| | M.W. | m/z[M − OH]⁺ |
| Cholesterol | 386.3549 | 369.3510 |

When the imaging mass spectrometry image obtained in Example 1 was observed, metabolites in Table 1 were confirmed. Specifically, propionic acid and butyric acid were distributed in the intestinal contents of the colon, and lactic acid was distributed in the smooth muscle of the small intestine and cecum. Long chain fatty acids such as palmitic acid were distributed in the intestinal contents and the villous region of the small intestine, while cholesterol was distributed in the intestinal intraepithelial regions of the colon and small intestine.

### Comparative Example 1

A tissue piece was analyzed by mass spectrometry image in the same manner as in Example 1 except that DAN (1,5-diaminonaphthalene) was used instead of CHCA. As a result, the detection of cholesterol was unclear.

What is claimed is:

1. A method for analyzing an organic acid in a tissue piece, the method comprising, in order:
a derivatization step of derivatizing an organic acid present in a tissue piece by dehydration condensation;
a coating step of coating the tissue piece with a matrix having a carboxyl group by a vapor deposition method; and
a detection step of performing matrix-assisted laser desorption/ionization mass spectrometry on the tissue piece to detect the derivatized organic acid.

2. The method for analyzing according to claim 1, wherein the matrix is at least one of x-cyano-4-hydroxycinnamic acid and 2,5-dihydroxybenzoic acid.

3. The method for analyzing according to claim 1, wherein in the derivatization step, the organic acid is derivatized using a derivatizing agent and a basic substance.

4. The method for analyzing according to claim 1, wherein in the detection step, cholesterol is detected in addition to the organic acid.

5. The method for analyzing according to claim 1, wherein in the detection step, the matrix-assisted laser desorption/ionization mass spectrometry is matrix-assisted laser desorption/ionization mass spectrometry imaging method, and an image showing a distribution of the organic acid is obtained.
